(19) United States
(12) Patent Application Publication
(10) Pub. No.: US 2025/0149988 A1
(43) Pub. Date: May 8, 2025

(54) POWER STAGE CIRCUIT WITH DUAL-OUTPUT AND METHOD THEREOF

(71) Applicant: Monolithic Power Systems, Inc., Kirkland, WA (US)

(72) Inventor: Jeffrey M. Jull, Mannford, OK (US)

(21) Appl. No.: 18/934,868

(22) Filed: Nov. 1, 2024

Related U.S. Application Data
(60) Provisional application No. 63/547,651, filed on Nov. 7, 2023.

(51) Int. Cl. H02M 3/158; H02M 1/00; H02M 1/088

(52) U.S. Cl. CPC H02M 3/1586; H02M 1/0032; H02M 1/088

(57) ABSTRACT

An integrated circuit includes a switching control pin, a first power unit, a second power unit, and a driving control circuit. The switching control pin is configured to receive a control signal. The first power unit has at least one power switch. The second power unit has at least one power switch. The driving control circuit is configured to provide a first driving signal to the first power unit in response to the control signal, and to provide a second driving signal to the second power unit in response to the control signal. The first power unit is turned on to perform a switching operation and the second power unit is turned off under a first load condition, and both the first power unit and the second power unit are turned on to perform a switching operation under a second load condition.

### CROSS-REFERENCE TO RELATED APPLICATION(S)

The present application claims the benefit of and priority to U.S. Provisional Patent Application Ser. 63/547,651 filed Nov. 7, 2023, which is hereby incorporated fully by reference into the present application.

### TECHNICAL FIELD

The present disclosure relates generally to power circuits, and more particularly but not exclusively to voltage regulators.

### BACKGROUND OF THE INVENTION

Power converters such as switch mode voltage regulators are widely used to provide power to electronic devices. For some portable electronic devices such as laptops, the power management is a critical issue. These devices demand higher power efficiency and lower power consumption under light load condition. Various power modes or power-saving features are often provided to save the power consumption and support longer battery life. For example, some functions are not performed, disabled, or shut down to save quiescent current during low power mode. Therefore, for a power converter, it is desirable to improve the light load efficiency to prolong the battery life of electronic devices.

### SUMMARY OF THE INVENTION

According to an embodiment of the present disclosure, an integrated circuit is provided. The integrated circuit includes a switching control pin, a first power unit, a second power unit, and a driving control circuit. The switching control pin is configured to receive a control signal. The first power unit has at least one power switch. The second power unit has at least one power switch. The driving control circuit is configured to provide a first driving signal to the first power unit in response to the control signal, and to provide a second driving signal to the second power unit in response to the control signal. The first power unit is turned on to perform a switching operation and the second power unit is turned off under a first load condition, and both the first power unit and the second power unit are turned on to perform a switching operation under a second load condition.

According to another embodiment of the present disclosure, an integrated circuit is provided. The integrated circuit includes a switching control pin, a mode pin, a first power unit, a second power unit, and a driving control circuit. The switching control pin is configured to receive a control signal. The mode pin is configure to receive a mode command. The first power unit has a first current capability. The second power unit has a second current capability, where the second current capability is greater than the first current capability. The driving control circuit is configured to provide a first driving signal to the first power unit in response to the control signal and the mode command, and to provide a second driving signal to the second power unit in response to the control signal and the mode command. The first power unit is located in a first region and the second power unit is located in a second region. Each of the first power unit and the second power unit includes a first switch and a second switch. The first switch has a first terminal, a second terminal and a control terminal, where the first terminal of the first switch is configured to receive an input voltage. The second switch has a first terminal, a second terminal and a control terminal, where the first terminal of the second switch is coupled to the second terminal of the first switch, and the second terminal of the second switch is configured to be coupled to a reference voltage level.

According to yet another embodiment of the present disclosure, a multiphase voltage regulator is provided. The multiphase voltage regulator includes power stage circuits and a control circuit. Each of the power stage circuit is configured to provide a phase current. Each power stage circuit includes at least one power switch. The control circuit is coupled to the power stage circuits. One of the power stage circuits includes a switching control pin, a first power unit, a second power unit, and a driving control circuit. The switching control pin is configured to receive a control signal from the control circuit. The first power unit has at least one power switch. The second power unit has at least one power switch. The driving control circuit is configured to provide at least one first driving signal to the first power unit in response to the control signal, and provide at least one second driving signal to the second power unit in response to the control signal. The first power unit is turned on to perform a switching operation and the second power unit is turned off under a first load condition, and both the first power unit and the second power unit are turned on to perform a switching operation under a second load condition.

### BRIEF DESCRIPTION OF THE DRAWINGS

The present disclosure can be further understood with reference to the

following detailed description and appended drawings, where like elements are provided with like reference numerals. These drawings are only for illustration purpose, thus may only show part of the devices and are not necessarily drawn to scale.

FIG. 1 is a schematic block diagram of a multi-phase voltage regulator in accordance with an embodiment of the present disclosure.

FIG. 2 is a schematic diagram of a multi-phase voltage regulator in accordance with an embodiment of the present disclosure.

FIG. 3 is a schematic diagram of a multi-phase voltage regulator in accordance with another embodiment of the present disclosure.

FIGS. 4A-4F are schematic block diagrams of a power stage circuit in accordance with some embodiments of the present disclosure.

FIG. 5 is a flowchart of a method 500 for controlling a power stage circuit in accordance with an embodiment of the present disclosure.

### DETAILED DESCRIPTION

Various embodiments of the present disclosure will now be described. In the following description, some specific details, such as example circuits and example values for these circuit components, are included to provide a thorough understanding of embodiments. One skilled in the relevant art will recognize, however, that the present disclosure can be practiced without one or more specific details, or with other methods, components, materials, etc. In other instances, well-known structures, materials, processes or operations are not shown or described in detail to avoid obscuring aspects of the present disclosure.

Throughout the specification and claims, the phrases “in one embodiment”, “in some embodiments”, “in one implementation”, and “in some implementations” as used includes both combinations and sub-combinations of various features described herein as well as variations and modifications thereof. These phrases used herein do not necessarily refer to the same embodiment, although it may. Those skilled in the art should understand that the meanings of the terms identified above do not necessarily limit the terms, but merely provide illustrative examples for the terms. It is noted that when an element is “connected to” or “coupled to” the other element, it means that the element is directly connected to or coupled to the other element, or indirectly connected to or coupled to the other element via another element. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

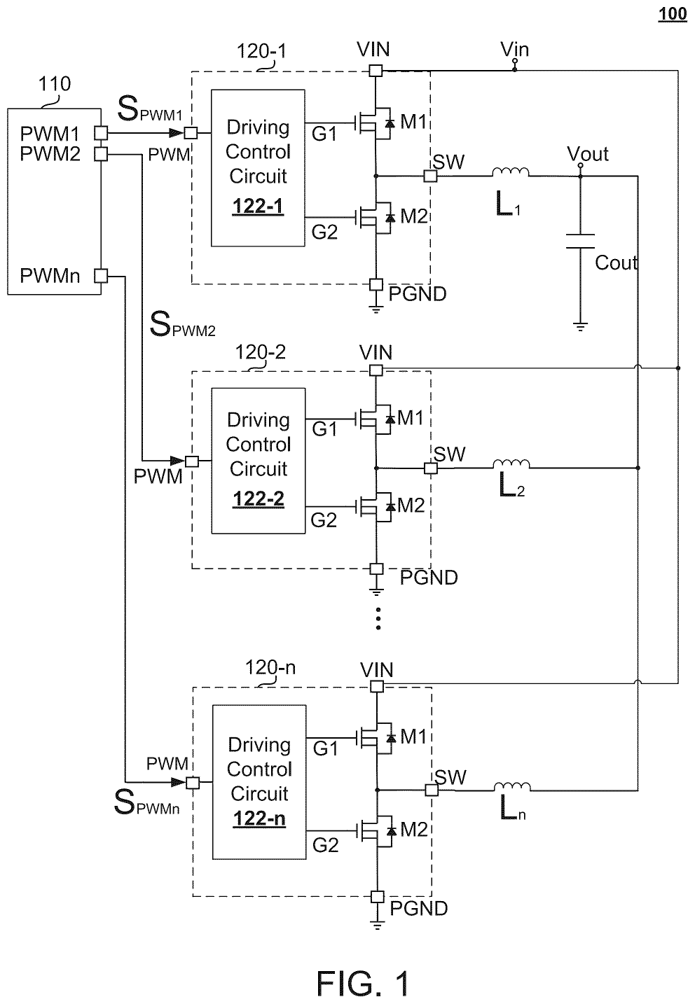

FIG. 1 is a schematic block diagram of a multi-phase voltage regulator 100 in accordance with an embodiment of the present disclosure. The multi-phase voltage regulator 100 includes a control circuit 110 and multiple power stage circuits 120-1, 120-2, 120-3 . . . , 120-n, where n is a natural number greater than 1. In one embodiment, each one of the power stage circuits 120 includes at least one power switch and is configured to provide one phase of the multi-phase voltage regulator 100. The n power stage circuits are coupled in parallel, and each of the power stage circuit to provide a phase current to the load. Each power stage circuits is configured to share the input voltage Vin and the output voltage Vout. In one embodiment, the n power stage circuits are interleaved in n phases to reduce current ripple at the input and output and improve efficiency.

In one implementation, the multiphase voltage regulator 100 is a multiphase buck converter. However, the present disclosure is not limited thereto. The multiphase voltage regulator 100 may be a multiphase boost converter, a trans-inductor voltage regulator (TLVR), a multiphase DC-DC converters, or any multiphase converters. In some implementations, the multiphase voltage regulator 100 is an isolated converter. In some other implementations, the multiphase voltage regulator 100 is a non-isolated converter.

In one embodiment, the control circuit 110 is an integrated circuit (IC) and each one of the power stage circuits 120 is an IC. As shown in FIG. 1, the control circuit 110 includes n switching control pins (PWM1, PWM2, . . . , PWMn) to provide n phase control signals S_{PWM1}, S_{PWM2}, . . . , S_{PWMn} to n power stage circuits 120-1, 120-2, 120-3 . . . 120-n respectively for controlling the corresponding power stage circuits 120. For example, the controller 110 provides the control signals S_{PWM1} to power stage circuit 120-1 through the switching control pin PWM1, provides the control signals S_{PWM2} to power stage circuit 120-2 through the switching control pin PWM2. Each one of the power stage circuits 120 includes the driving control circuit and the power switches M1 and M2. Each one of the power stage circuits 120 further includes a switching control pin PWM, a VIN pin, an output pin SW, and a PGND pin. Each one of the switching control pins of the power stage circuits 120-1, 120-2, . . . 120-n receives the corresponding control signal S_{PWM}. For example, the switching control pin PWM of the power stage circuit 120-1 receives the control signal S_{PWM1}, the switching control pin PWM of the power stage circuit 120-2 receives the control signal S_{PWM2}. Each one of the VIN pins is coupled to the voltage source terminal Vin to receive an input voltage synchronously. Each one of the PGND pins is coupled to the reference voltage level (e.g., ground). Each one of the output pins SW is coupled to the output voltage terminal Vout through the corresponding inductor of the inductors L₁, L₂, . . . , Lₙ, to provide the output voltage to a load.

Each of the driving control circuits (122-1, 122-2, . . . 122-n) of the power stage circuits 120 provides a gate driving signal G1 to the control terminal of the power switch M1 and a gate driving signal G2 to the control terminal of the power switch M2 based on the PWM control signal S_{PWM}. The first terminal of the power switch M1 is coupled to the VIN pin, the second terminal of the power switch M1 is coupled to the first terminal of the power switch M2 (e.g., the output pin SW), the second terminal of the power switch M2 is coupled to the PGND pin. The power switch M1/M2 perform a switching operation by turning on and turning off alternately in response to the gate driving signal G1/G2. For example, when the gate driving signal G1/G2 is at a high voltage level (V_{GS}≥Vth), the transistor M1/M2 is turned on, and when the gate driving signal G1/G2 is at a low voltage level (V_{GS}<Vth), the transistor M1/M2 is turned off. An output capacitor Cout is coupled to the output voltage terminal Vout to filter an output voltage.

In one embodiment, the control circuit 110 detects feedback signals, and regulates the control signals to control the power stage circuits 120 based on the detected feedback signals. The feedback signals may be the output voltage or the output current. In another embodiment, the multi-phase voltage regulator 100 further includes a feedback circuit (not shown). The feedback circuit provides the feedback signals to the control circuit 110. The control circuit 110 provides the control signal to regulate the operation of the power stage circuits 120 based on the received feedback signals. In yet another embodiment, the feedback signals is sent back to the control circuit 110 through the power stage circuits 120, so that the control signals provided to the power stage circuits 120 is regulated by the control circuit 110. In some embodiments, the control signals provided to the power stage circuits 120 are regulated by the control circuit 110 based on the data provided by the power stage circuits 120. In some embodiments, the data may include temperature information, current signals, voltage signals, fault signals, and other detecting signals.

In one embodiment, each phase provides the corresponding output current respectively, and the n phase connected in parallel could be switched synchronously to provide a total large output current to meet the load requirements, and to decrease the input and output ripple at the same time. In another embodiment, the output current of each phase could be adjusted based on the load requirements.

In some embodiment, under light load condition, that is, when the load requires a lower output current, the multi-phase voltage regulator 100 operates in a single phase mode. Specifically, the control circuit 110 receives a single phase mode command, the controller will enable the phase 1, and disable the remaining phases (i.e., phases 2-n). Accordingly, only the power stage circuit 120-1 is activated to supply the output load current, while the other power stage circuits 120-2 to 120-n are deactivated.

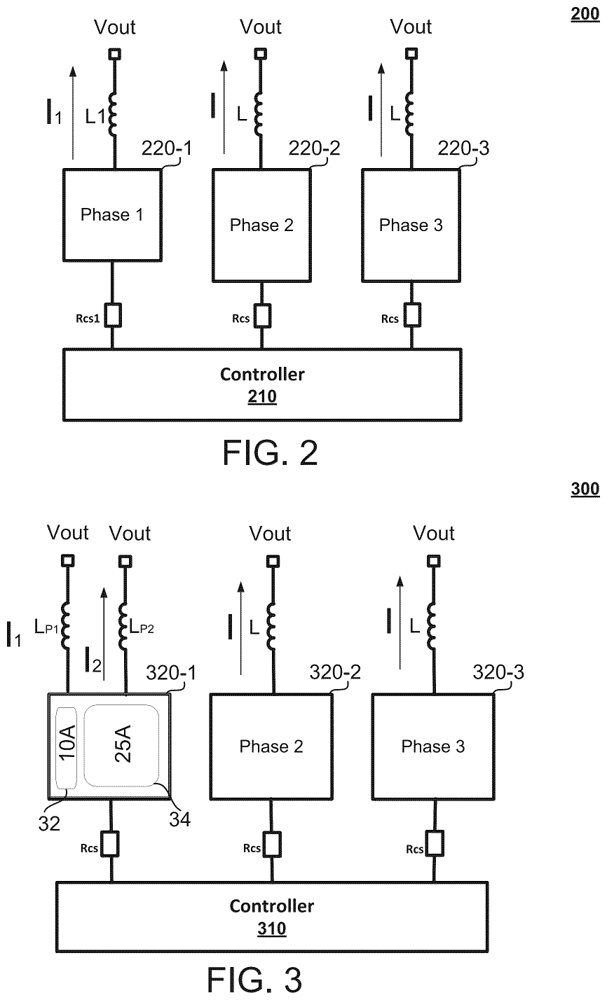

For some light load conditions, a heterogeneous phase configuration is applied to the multi-phase voltage regulator. FIG. 2 is a schematic diagram of a multi-phase voltage regulator 200 in accordance with an embodiment of the present disclosure. As shown in FIG. 2, the multi-phase voltage regulator 200 includes a controller IC 210 and multiple power stage ICs 220-1, 220-2, and 220-3. Specifically, the power stage IC 220-1 for phase 1 has a smaller power unit to supply a lower output current to the load. Additionally, a larger inductance L1 is used for the power stage circuit 220-1 for Phase 1. Accordingly, the efficiency at the light load is improved. On the other hand, for full phase operation, all phases (i.e., all of the power stage IC 220-1, 220-2, and 220-3) are activated to supply a larger output current to the load under heavy load condition. In such cases, since the power stage IC 220-1 for phase 1 supply a lower output current (e.g., I₁<I) to the load, the current distribution of all phases and the corresponding thermal power need to be considered, and the controller IC 210 has to provide the corresponding functions to control the power stage IC 220-1 for phase 1.

FIG. 3 is a schematic diagram of a multi-phase voltage regulator 300 in accordance with another embodiment of the present disclosure. In this embodiment, the power stage IC 320-1 for phase 1 has the same power capability to supply the same phase current (e.g., I=35 A) to the load as the other power stage ICs 320-2 and 320-3. Specifically, under light load condition, the multi-phase voltage regulator 300 is operated in a single phase mode. In this case, only the power stage IC 320-1 is turned on to perform a switching operation, while the other power stage IC 320-2 to 320-n are turned off to stop switching. Specifically, a power unit 32 having a first current capability (e.g., I₁=10 A) is turned on to perform a switching operation to supply a lower output current to the load, while another power unit 34 having a second current capability (e.g., I₂=25 A) is turned off. Under heavy load condition, the multi-phase voltage regulator 300 is operated in a full phase mode, and all of the power stage ICs 320-1, 320-2, and 320-3 are turned on to perform a switching operation to supply a larger output current (e.g., 3*I=105 A) to the load. In such cases, both the power unit 32 and the power unit 34 of the power stage circuit 320-1 for phase 1 are turned on to perform a switching operation to supply the phase current (e.g., I₁+I₂=I=35 A) to the load.

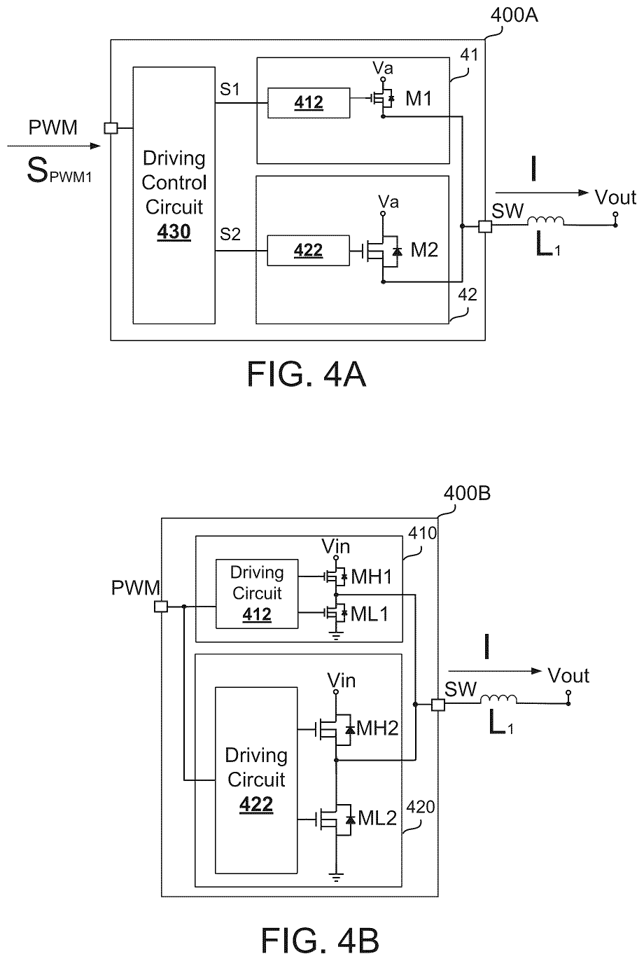

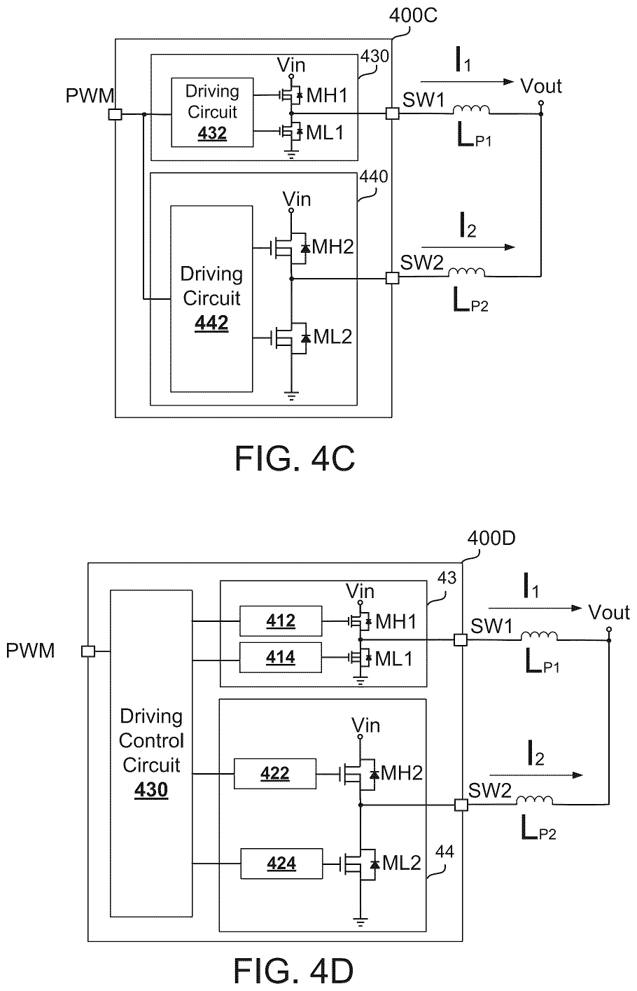

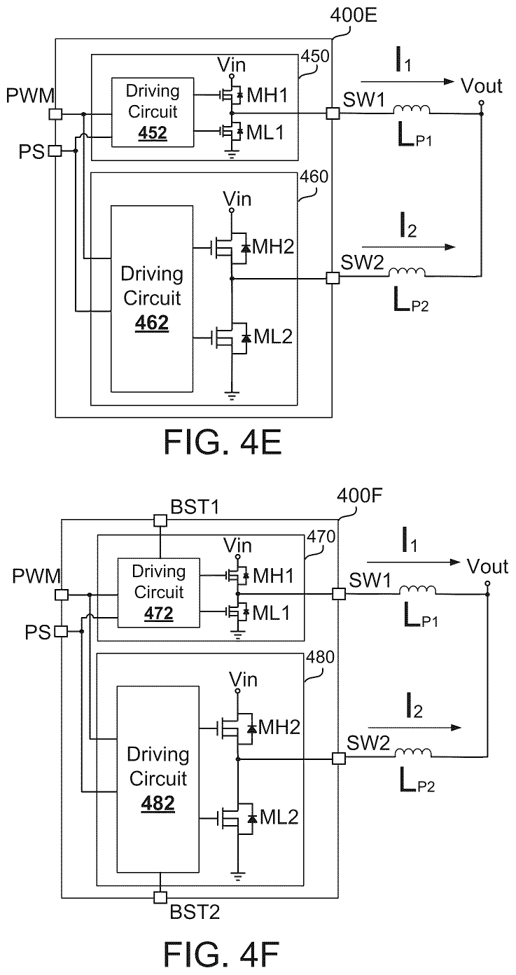

FIG. 4A is a schematic diagram of a power stage circuit 400A in accordance with one embodiment of the present disclosure. In this embodiment, the power stage circuit 400A is an IC. As shown in FIG. 4A, the power stage circuit 400A includes a first power unit 41, a second power unit 42, and a driving control circuit 430. In one embodiment, the first power unit 41 and the second power unit 42 are integrated in the power stage IC 400A while they are physically separated. For instance, the first power unit 41 is located in a first region and the second power unit 42 is located in a second region. The first power unit 410 includes at least one power switch M1. The second power unit 420 includes at least one power switch M2. In one embodiment, the first power unit 41 includes a driving circuit 412 to drive the power switch M1. In one embodiment, the second power unit 42 includes a driving circuit 422 to drive the power switch M2.

In one embodiment, the power stage circuit 400A further includes a switching control pin PWM, and an output pin SW. The driving control circuit 430 is configured to provide a first driving signal S1 to the first power unit 41 in response to the control signal S_{PWM1}, and to provide a second driving signal S2 to the second power unit 42 in response to the control signal S_{PWM1}. In one implementation, when the driving signal S1/S2 is at a high voltage level, the power unit 41/42 is turned on to perform a switching operation, and when the driving signal S1/S2 is at a low voltage level, the power unit 41/42 is turned off to stop switching. The first power unit 41 receives the first driving signal S1, and provides the output voltage signal at the output pin SW to the load via the inductor L₁. The second power unit 42 receives the second driving signal S2, and provides the output voltage signal at the output pin SW to the load via the inductor L₁.

In one embodiment, the PWM control signal indicates a load condition. The first power unit 41 is turned on to perform a switching operation and the second power unit is turned off under a first load condition. On the other hand, under a second load condition, both the first power unit 41 and the second power unit 42 are turned on to perform a switching operation.

For instance, when the PWM indicates a light load condition, a first power unit 41 is enabled and a second power unit 42 is disabled to provide a first current (e.g., 10 A) to the load.

In another embodiment, the PWM control signal indicates a power mode. For example, when the switching control signal S_{PWM1} indicates a low power mode, a first power unit 42 having a first current capability (e.g., 10 A), is enabled to provide a first current to the load, while the second power unit 42 is disabled. In another example, when the switching control signal S_{PWM1} indicates a high power mode, a second power unit 42, having a higher current capability (e.g., 25 A) than the first power unit 41, is enabled to provide a second current to the load, while the first power unit 41 is disabled. In some embodiments, when the switching control signal S_{PWM1} indicates a normal operation mode, both the first power unit 41 and the second power unit 42 are enabled to provide the total output current (e.g., 35 A) to the load.

FIG. 4B is a schematic diagram of a power stage circuit 400B in accordance with another embodiment of the present disclosure. It should be noted, the driving control circuit 430 is not shown. In this embodiment, each of the first power unit 410 and the second power unit 420 includes two power switches. Specifically, the switch MH1 has a first terminal configured to receive an input voltage Vin, a second terminal coupled to the first terminal of the switch ML1, and a control terminal to receive a gate driving signal from the driving circuit 412. The switch ML1 has a first terminal coupled to the switch MH1 and the output pin SW, a second terminal configured to be coupled to a reference voltage level (e.g., ground), and a control terminal to receive a gate driving signal from the driving circuit 412. Similarly, the switches MH2 and ML2 are coupled in series between the input node to receive the input voltage Vin and the reference node to receive the reference voltage level. The control terminal of the switch MH2 is configured to receive a gate driving signal from the driving circuit 422. The control terminal of the switch ML2 is configured to receive a gate driving signal from the driving circuit 422.

FIG. 4C is a schematic diagram of a power stage circuit 400C in accordance with yet another embodiment of the present disclosure. In this embodiment, the power stage circuit 400C includes a first output pin SW1 coupled to the first power unit 430, and a second output pin SW2 coupled to the second power unit 440. As shown in FIG. 4C, the first power unit 430 provides a first current I₁ at the first output pin SW1 to the load via the inductor L_{P1}. The second power unit 410 provides a second current I₂ at the second output pin SW2 to the load via the inductor L_{P2}. In this embodiment, the inductance of the inductor L_{P1} is larger than the inductance of the inductor L_{P2} or larger than the inductance of the inductor L₁ to further improve the efficiency under light load condition. The sum of the first current I₁ and the second current I₂ is a phase current I for a multiphase voltage regulator.

FIG. 4D is a schematic diagram of a power stage circuit 400D in accordance with yet another embodiment of the present disclosure. In this embodiment, the first power unit 43 includes driving circuits 412 and 414 to provide the gate driving signal to the switch MH1 and ML1, respectively. The second power unit 43 includes driving circuits 412 and 414 to provide the gate driving signal to the switch MH1 and ML1, respectively.

FIG. 4E is a schematic diagram of a power stage circuit 400E in accordance with yet another embodiment of the present disclosure. In this embodiment, the power stage circuit 400E further includes a mode pin PS coupled to the first power unit 450 and the second power unit 460. In this embodiment, the mode command is received from the controller IC via the mode pin PS. For example, the mode command indicates a load condition. A light load condition may include a standby mode, a sleep mode, an idle mode, or a low power mode. When the mode command indicates a light load condition, the first power unit 450 is turned on to perform a switching operation and the second power unit is turned off. When the mode command indicates a heavy load condition, the first power unit 450 and the second power unit 460 are turned on to perform a switching operation.

In one implementation, the mode command indicates a single phase operation. The first power unit 450 is turned on to perform a switching operation and the second power unit 460 is turned off when the mode command indicates a single phase operation. In another implementation, the mode command indicates a full phase operation. The first power unit 450 and the second power unit 460 are turned on to perform a switching operation when the mode command indicates a full phase operation.

In some implementations, the mode command indicates the power unit 450/460 to be enabled and/or disabled the switching operation.

In some other implementations, the mode command indicates a continuous conduction mode (CCM) operation. The first power unit 450 and the second power unit 460 are turned on to perform a switching operation when the mode command indicates a CCM operation. In some other implementations, the mode command indicates a discontinuous conduction mode (DCM) operation. The first power unit 450 is turned on to perform a switching operation and the second power unit 460 is turned off when the mode command indicates a DCM operation.

FIG. 4F is a schematic diagram of a power stage circuit 400F in accordance with yet another embodiment of the present disclosure. In this embodiment, the power stage circuit 400F further includes a BST1 pin and a BST2 pin. The BST1 pin is configured to be coupled to a bootstrap circuit to receive the bootstrap voltage to drive the power switch MH1. For example, a BST capacitor is connected between the BST1 pin and the SW1 pin. Similarly, the BST2 pin is configured to be coupled to a bootstrap circuit to receive the bootstrap voltage to drive the power switch MH2. That is, the driving circuit 472 of the first power unit 470 and the driving circuit 482 of the second power unit 480 are physically separated. As a result, when only the first power unit 470 is enabled under a light load condition, the power loss could be reduced since the driving circuit 482 of the second power unit 480 are not connected to the driving circuit 472 and receive the bootstrap voltage via independent BST2 pin.

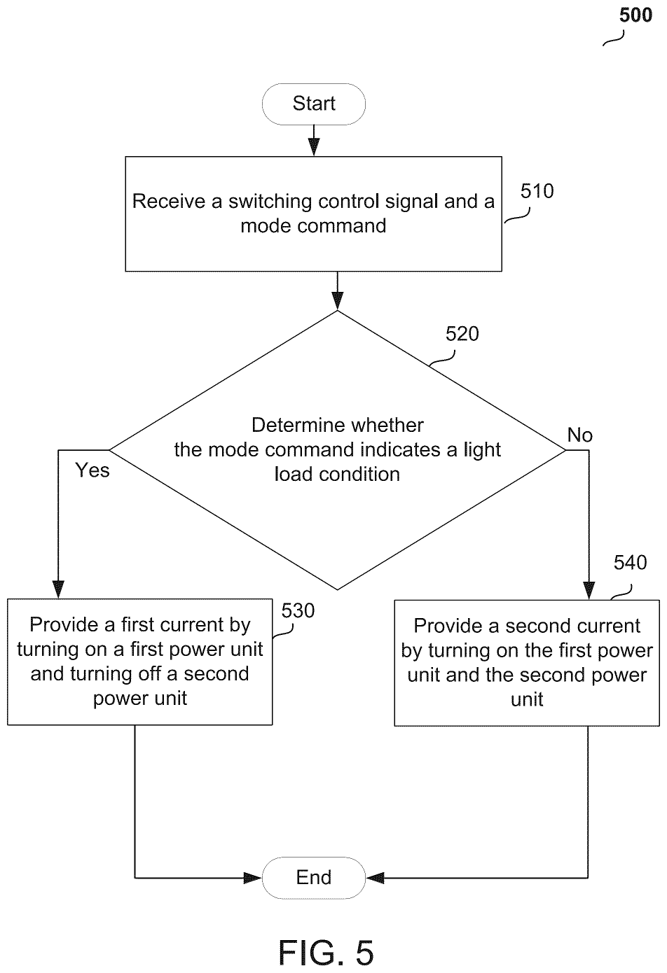

FIG. 5 is a flowchart of a method 500 for controlling a power stage circuit in accordance with an embodiment of the present disclosure. The method may be performed by a power stage circuit 400A-400F as shown in FIGS. 4A-4F. The method 500 includes the following actions. In action 510, a switching control signal and a mode command are received. In action 520, whether the mode command indicates a light load condition is determined. When the mode command indicates a light load condition is received, a first current is provided to the load by turning on a first power unit and turning off a second power unit as shown in action 530. In one embodiment, when the mode command indicates a normal operation, a second current is provided to the load by turning on both the first power unit and the second power unit as shown in action 540. In another embodiment, a third current is provided to the load by turning on the second power unit and turning off the first power unit in response to the mode command. Although the flowchart of FIG. 5 shows a sequential action. It is obvious to persons skilled the art that these actions could be performed in any order.

It should be understood that, the circuit and the related components, circuit structures, signals, and waveforms described or shown above in the present disclosure are only for illustration purpose. However, the present disclosure is not limited thereto. Persons having ordinary skill in the art may understood that the control circuit of the present disclosure could be realized, according to practical applications, by any other circuits with different circuit structures, and thus controlled by different types of the corresponding signals to achieve the corresponding functions. For example, the compensation circuit, the ramp generation circuit, the comparison circuit and the logic circuit could be realized by a digital circuit, an analog circuit, a software, an automatic generation circuit by hardware description language, or a combination of the above.

It will be appreciated by persons skilled in the art that the present disclosure is not limited to what has been particularly shown and described herein above. Rather the scope of the present disclosure is defined by the claims and includes both combinations and sub-combinations of the various features described hereinabove as well as variations and modifications thereof which would occur to persons skilled in the art upon reading the foregoing description and which are not in the prior art.

What is claimed is:

1. An integrated circuit, comprising:
a switching control pin configured to receive a control signal;
a first power unit having at least one power switch;
a second power unit having at least one power switch; and
a driving control circuit configured to provide a first driving signal to the first power unit in response to the control signal, and to provide a second driving signal to the second power unit in response to the control signal;
wherein the first power unit is turned on to perform a switching operation and the second power unit is turned off under a first load condition, and both the first power unit and the second power unit are turned on to perform a switching operation under a second load condition.

2. The power stage circuit of claim 1, wherein each of the first power unit and the second power unit comprises:
a first switch having a first terminal, a second terminal and a control terminal, wherein the first terminal of the first switch is configured to receive an input voltage; and
a second switch having a first terminal, a second terminal and a control terminal, wherein the first terminal of the second switch is coupled to the second terminal of the first switch, and the second terminal of the second switch is configured to be coupled to a reference voltage level.

3. The integrated circuit of claim 2, further comprising:
an output pin configured to provide a phase current for a multiphase voltage regulator, wherein the output pin is coupled to the first terminal of the second switch of the first power unit and the first terminal of the second switch of the second power unit.

4. The integrated circuit of claim 2, further comprising:
a first output pin coupled to the first terminal of the second switch of the first power unit, wherein the first output pin is configured to provide a first current; and
a second output pin coupled to the first terminal of the second switch of the second power unit, wherein the second output pin is configured to provide a second current;
wherein the sum of the first current and the second current is a phase current for a multiphase voltage regulator.

5. The integrated circuit of claim 1, wherein the control signal indicates a power mode.

6. The integrated circuit of claim 1, wherein the control signal indicates a load condition.

7. The integrated circuit of claim 1, further comprising:
a mode pin coupled to the first power unit and the second power unit, wherein the mode pin is configured to receive a mode command;
wherein the first power unit is turned on and the second power unit is turned off when the mode command indicates a light load condition.

8. The integrated circuit of claim 1, further comprising:
a mode pin coupled to the first power unit and the second power unit, wherein the mode pin is configured to receive a mode command;
wherein the first power unit and the second power unit are turned on to perform a switching operation when the mode command indicates a heavy load condition.

9. The integrated circuit of claim 1, further comprising:
a mode pin coupled to the first power unit and the second power unit, wherein the mode pin is configured to receive a mode command;
wherein the first power unit is turned on to perform a switching operation and the second power unit is turned off when the mode command indicates a discontinuous conduction mode (DCM) operation.

10. The integrated circuit of claim 1, further comprising:
a mode pin coupled to the first power unit and the second power unit, wherein the mode pin is configured to receive a mode command;
wherein the first power unit and the second power unit are turned on to perform a switching operation when the mode command indicates a continuous conduction mode (CCM) operation.

11. The integrated circuit of claim 1, further comprising:
a mode pin coupled to the first power unit and the second power unit, wherein the mode pin is configured to receive a mode command;
wherein the first power unit is turned on to perform a switching operation and the second power unit is turned off when the mode command indicates a single phase operation.

12. The integrated circuit of claim 1, further comprising:
a mode pin coupled to the first power unit and the second power unit, wherein the mode pin is configured to receive a mode command;
wherein the first power unit and the second power unit are turned on to perform a switching operation when the mode command indicates a full phase operation.

13. An integrated circuit, comprising:
a switching control pin configured to receive a control signal;
a mode pin configured to receive a mode command;
a first power unit having a first current capability;
a second power unit having a second current capability, wherein the second current capability is greater than the first current capability;
a driving control circuit configured to provide a first driving signal to the first power unit in response to the control signal and the mode command, and to provide a second driving signal to the second power unit in response to the control signal and the mode command;
wherein the first power unit is located in a first region and the second power unit is located in a second region;
wherein each of the first power unit and the second power unit comprises:
a first switch having a first terminal, a second terminal and a control terminal, wherein the first terminal of the first switch is configured to receive an input voltage; and
a second switch having a first terminal, a second terminal and a control terminal, wherein the first terminal of the second switch is coupled to the second terminal of the first switch, and the second terminal of the second switch is configured to be coupled to a reference voltage level.

14. The power stage circuit of claim 13, further comprising:
a first output pin coupled to the first terminal of the second switch of the first power unit, wherein the first output pin is configured to be coupled to a first inductor; and
a second output pin coupled to the first terminal of the second switch of the second power unit, wherein the second output pin is configured to be coupled to a second inductor, wherein an inductance of the first inductor is greater than an inductance of the second inductor.

15. The integrated circuit of claim 14, wherein the first power unit is turned on to provide a first current to a load via the first output pin when the mode command indicates a light load condition.

16. The integrated circuit of claim 14, wherein when the mode command indicates a heavy load condition, the first power unit is turned on provide a first current to a load via the first output pin and the second power unit is turned on to provide a second current to the load via the second output pin; wherein the sum of the first current and the second current is a phase current for a multiphase voltage regulator.

17. A multiphase voltage regulator, comprising:
a plurality of power stage circuits, each of which is configured to provide a phase current, wherein each power stage circuit comprises at least one power switch; and
a control circuit coupled to the power stage circuits;
wherein one of the power stage circuits comprises:
a switching control pin configured to receive a control signal from the control circuit;
a first power unit having at least one power switch;
a second power unit having at least one power switch; and
a driving control circuit configured to provide at least one first driving signal to the first power unit in response to the control signal, and provide at least one second driving signal to the second power unit in response to the control signal
wherein the first power unit is turned on to perform a switching operation and the second power unit is turned off under a first load condition, and both the first power unit and the second power unit are turned on to perform a switching operation under a second load condition.

18. The multiphase voltage regulator of claim 17, wherein each of the first power unit and the second power unit comprises:
a first switch having a first terminal, a second terminal and a control terminal, wherein the first terminal of the first switch is configured to receive an input voltage; and
a second switch having a first terminal, a second terminal and a control terminal, wherein the first terminal of the second switch is coupled to the second terminal of the first switch, and the second terminal of the second switch is configured to be coupled to a reference voltage level.

19. The multiphase voltage regulator of claim 17, further comprising:
a first output pin coupled to the first terminal of the second switch of the first power unit, wherein the first output pin is configured to provide a first current; and
a second output pin coupled to the first terminal of the second switch of the second power unit, wherein the second output pin is configured to provide a second current;
wherein the sum of the first current and the second current is the phase current.

20. The multiphase voltage regulator of claim 17, further comprising:
a mode pin coupled to the first power unit and the second power unit, wherein the mode pin is configured to receive a mode command;
wherein the first power unit is turned on and the second power unit is turned off when the mode command indicates a light load condition.

21. The multiphase voltage regulator of claim 17, further comprising:
a mode pin coupled to the first power unit and the second power unit, wherein the mode pin is configured to receive a mode command;
wherein the first power unit is turned on and the second power unit is turned off when the mode command indicates a discontinuous conduction mode (DCM) operation.

22. The multiphase voltage regulator of claim 17, further comprising:
a mode pin coupled to the first power unit and the second power unit, wherein the mode pin is configured to receive a mode command;
wherein the first power unit and the second power unit are turned on when the mode command indicates a full phase operation.
